(19) United States
(12) Patent Application Publication
(10) Pub. No.: US 2012/0125539 A1
(43) Pub. Date: May 24, 2012

(54) CURING DEVICE AND DISPLAY PANEL ASSEMBLY APPARATUS USING THE SAME

(75) Inventors: Chengming He, Shenzhen (CN); Yu-Wu Huang, Shenzhen (CN); Chien-pang Lee, Shenzhen (CN)

(73) Assignee: Shenzhen China Star Optoelectronics Technology Co., LTD., Shenzhen City (CN)

(21) Appl. No.: 13/219,908

(22) Filed: Aug. 29, 2011

(30) Foreign Application Priority Data
Nov. 18, 2010 (CN) 201010553814.X

(51) Int. Cl. B32B 37/06; B29C 65/14; G21K 5/08; B05C 11/00

(52) U.S. Cl. 156/378; 118/712; 156/383; 156/379.9; 250/454.11

(57) ABSTRACT

The present invention provides a curing device and a display panel assembly apparatus using the same. The display panel assembly apparatus comprises a liquid crystal filling device, an alignment assembly device, a transporting device and the curing device. The curing device comprises a supporting stage configured to support the display panel; and a plurality of curing units disposed above the supporting stage, wherein the curing units are arranged according to a sealant pattern of the sealant. The present invention can reduce the number and used power of the curing units.

### FIELD OF THE INVENTION

The present invention relates to a field of a liquid crystal display technology, and more particularly to a curing device and a display panel assembly apparatus using the same.

### BACKGROUND OF THE INVENTION

Liquid crystal displays (LCDs) have been widely applied in electrical products. Currently, most of LCDs are backlight type LCDs which comprise a liquid crystal panel and a backlight module.

The liquid crystal panel is composed of two transparent substrates and a liquid crystal sealed there-between. In an assembly process of the liquid crystal panel, the liquid crystal is filled and sealed between the transparent substrates. Currently, the methods for filling the liquid crystal between the transparent substrates may be a vacuum siphon method and a one-drop filling (ODF) method. The filling time of the conventional vacuum siphon method is too long, and thus the ODF method is more suitable to a large-scale panel.

Taking the ODF method for example, in the ODF process, the liquid crystal is first dispensed on a glass substrate, and then another glass substrate can be aligned and assembled with the glass substrate with the dispensed liquid crystal, thereby forming a liquid crystal cell between the two glass substrates. Subsequently, a sealant between the two glass substrates is cured, thereby forming the liquid crystal display panel.

Currently, the curing of the sealant is performed by an ultraviolet (UV) lighting machine. The UV lighting machine has a plurality UV light lamps which are arranged densely above the display panel for emitting a UV light to cure the sealant of the display panel.

However, since the UV light lamps are arranged densely above the display panel, a large number of the lamps are needed to perform curing, and plenty of power and increased maintenance cost are needed. Furthermore, in a specific process, the UV light may deteriorate monomers contained in the liquid crystal cell. Therefore, a mask is added between the UV light lamps and the panel for sheltering the liquid crystal layer of the liquid crystal cell from the UV light, and thus the process cost is increased, and the process yield is difficult to control.

As a result, it is necessary to provide a curing device and a display panel assembly apparatus using the same to solve the problems existing in the conventional technologies, as described above.

### SUMMARY OF THE INVENTION

A primary object of the present invention is to provide a curing device for curing a sealant of a display panel, and the curing device comprises a supporting stage configured to support the display panel; and a plurality of curing units disposed above the supporting stage, wherein the curing units are arranged according to a sealant pattern of the sealant.

Another object of the present invention is to provide a display panel assembly apparatus, and the display panel assembly apparatus comprises a liquid crystal filling device configured to form a liquid crystal on a first substrate, wherein a sealant needed to be cured is formed on the first substrate; an alignment assembly device configured to align and assemble a second substrate on the first substrate for forming a display panel; a transporting device configured to transport the display panel from the alignment assembly device; and a curing device configured to completely cure the sealant of the display panel transported by the transporting device, wherein the curing device comprises a supporting stage configured to support the display panel; and a plurality of curing units disposed above the supporting stage, wherein the curing units are arranged according to a sealant pattern of the sealant.

In one embodiment of the present invention, the sealant pattern is formed as a frame-shaped pattern.

In one embodiment of the present invention, the curing units cure the sealant using a light curing method.

In one embodiment of the present invention, each of the curing units comprises a supporting bar and a light source, and the light source is disposed on the supporting bar.

In one embodiment of the present invention, the curing units cure the sealant using a heat curing method.

In one embodiment of the present invention, each of the curing units comprises a supporting bar and a heater, and the heater is disposed on the supporting bar.

In one embodiment of the present invention, the curing device further comprises at least one sensor to detect whether the curing units are arranged according to the sealant pattern.

In one embodiment of the present invention, the curing units and the display panel include alignment marks, respectively, and the sensor detects whether the curing units are aligned with the sealant by sensing the alignment marks.

In one embodiment of the present invention, the curing units are detachably disposed above the supporting stage.

The curing device and the display panel assembly apparatus using the same can arrange the curing units corresponding to the sealant pattern of the sealant, so as to reduce the number of elements and the used power, thereby reducing the apparatus and process cost, and the mask is not necessary for sheltering the liquid crystal layer. Furthermore, the number and position of the curing units of the curing device can be flexibly adjusted according to the size or number of the display panel, and thus suitable to be applied to the display panel with various sizes and number.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a schematic diagram showing a display panel assembly apparatus according to a first embodiment of the present invention;

FIG. 2 is a cross-sectional view showing a display panel according to the first embodiment of the present invention;

FIG. 3 and FIG. 4 are top views showing the display panel according to the first embodiment of the present invention;

FIG. 5 is a schematic diagram showing the curing device according to the first embodiment of the present invention;

FIG. 6 and FIG. 7 are schematic diagrams showing the curing units according to the first embodiment of the present invention; and

FIG. 8 is a schematic diagram showing a curing unit according to the first embodiment of the present invention; and

FIG. 9 is a schematic diagram showing a curing device according to a second embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

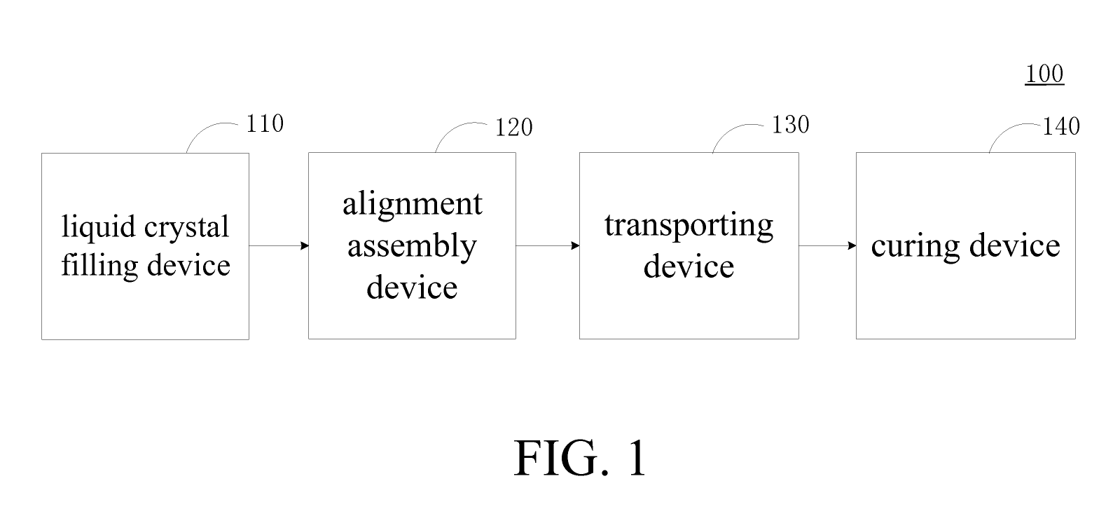

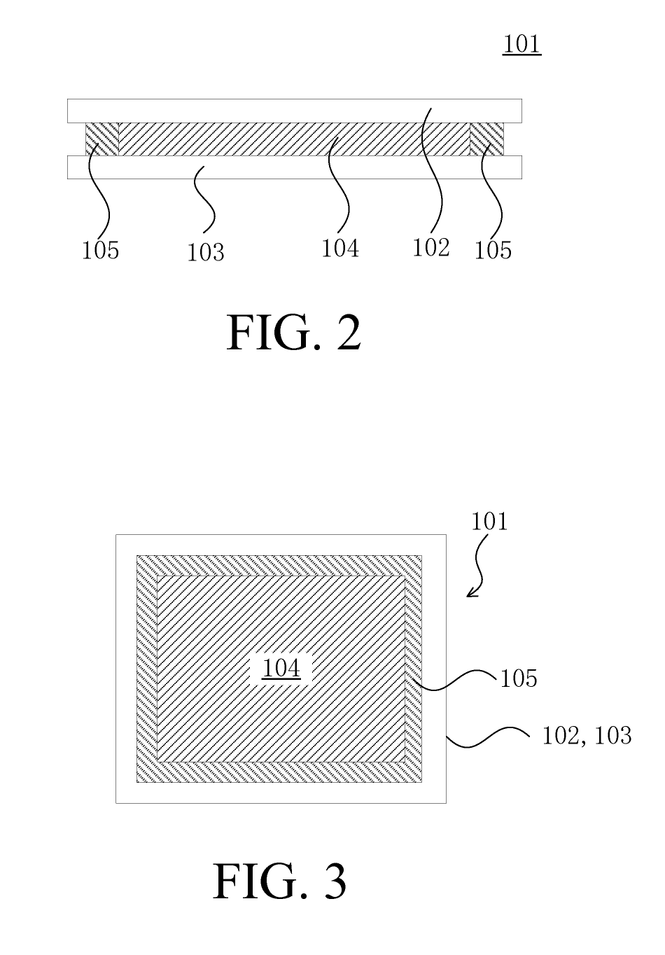

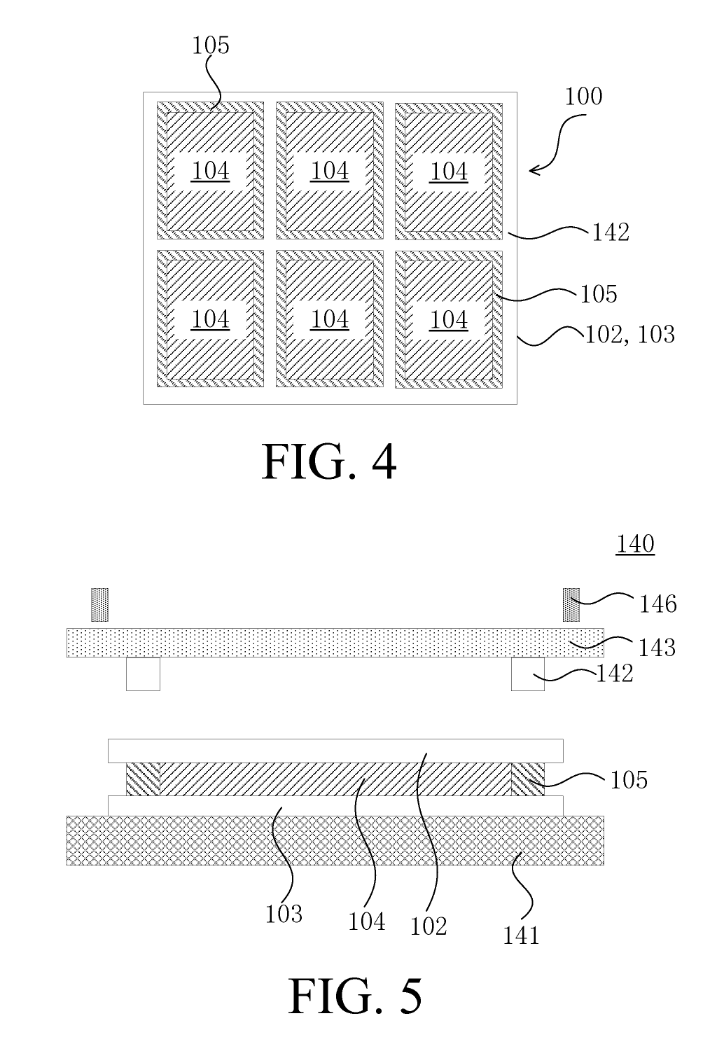

Referring to FIG. 1 through FIG. 4, FIG. 1 is a schematic diagram showing a display panel assembly apparatus according to a first embodiment of the present invention, and FIG. 2 is a cross-sectional view showing a display panel according to the first embodiment of the present invention, and FIG. 3 and FIG. 4 are top views showing the display panel according to the first embodiment of the present invention. The curing device 140 of the present embodiment may disposed or assembled in the display panel assembly apparatus 100 for curing at least one sealant 105 of a liquid crystal display panel 101. The liquid crystal display panel 101 may comprise a first substrate 102, a second substrate 103, a liquid crystal layer 104 and the sealant 105. The liquid crystal layer 104 and a sealant 105 are formed between the first substrate 102 and the second substrate 103. The sealant 105 can enclose and seal the liquid crystal layer 104 to form a liquid crystal cell. In this embodiment, only one sealant 105 between the first substrate 102 and the second substrate 103 is illustrated in FIG. 2 and FIG. 3. However, referring to FIG. 4, more sealants 105 may also be disposed between the first substrate 102 and the second substrate 103. In this case, the first substrate 102 and the second substrate 103 can be cut into a plurality of liquid crystal display panels 101 after curing the sealants 105.

Referring to FIG. 2 again, the first substrate 102 and the second substrate 103 may be glass substrates or flexible plastic substrates. In this embodiment, the first substrate 102 may be a glass substrate or other material substrate with color filters (CF), and the second substrate 103 may be a glass substrate or other material substrate with a thin film transistor (TFT) array. The sealant 105 is formed as a frame-shaped structure to enclose the liquid crystal layer 104. The sealant 105 may be a light-curing sealant or a heat-curing sealant. The light-curing sealant may be, for example, a UV Curable adhesive or a visible light curing glue.

Referring to FIG. 1 again, the display panel assembly apparatus 100 of the present embodiment may comprise a liquid crystal filling device 110, an alignment assembly device 120, a transporting device 130 and a curing device 140. The liquid crystal filling device 110 is configured to form a liquid crystal on the first substrate 102, wherein the at least one sealant 105 needed to be cured is formed on the first substrate 102. The liquid crystal filling device 110 can dispense the liquid crystal within the sealant 105 on the first substrate 102 using, for example, an ODF method. When the liquid crystal is dispensed on the first substrate 102 by the liquid crystal filling device 110, the coated sealant 105 on the first substrate 102 is uncured. In one embodiment, the liquid crystal filling device 110 can also form the liquid crystal between the first substrate 102 and the second substrate 103 using a vacuum siphon method.

Referring to FIG. 1 again, the alignment assembly device 120 of the present embodiment may be disposed downstream of the liquid crystal filling device 110 for aligning and assembling the second substrate 103 on the first substrate 102 to form the display pane 101. Referring to FIG. 3 again, the alignment assembly device 120 preferably aligns and assembles the first substrate 102 and the second substrate 103 in a vacuum environment to reduce defects, such as bubbles. For example, the alignment assembly device 120 may be positioned in a vacuum box to align and assemble the first substrate 102 and second substrate 103.

Referring to FIG. 1 again, the transporting device 130 of the present embodiment may be disposed between the alignment assembly device 120 and the curing device 140. The transporting device 130 is configured to transport the display panel 101 from the alignment assembly device 120 to the curing device 140. In this case, the transporting device 130 can transport the display panel 101 using robot arms, roller elements or other means.

Referring to FIG. 5, a schematic diagram showing the curing device according to the first embodiment of the present invention is illustrated. The curing device 140 is disposed downstream of the transporting device 130 configured to completely cure the sealant 105. The curing device 140 comprises a supporting stage 141 and a plurality of curing units 142. The supporting stage 141 may be disposed in a chamber (not shown) for supporting the display panel 101. The curing units 142 are disposed above the supporting stage 141 for curing the sealant 105.

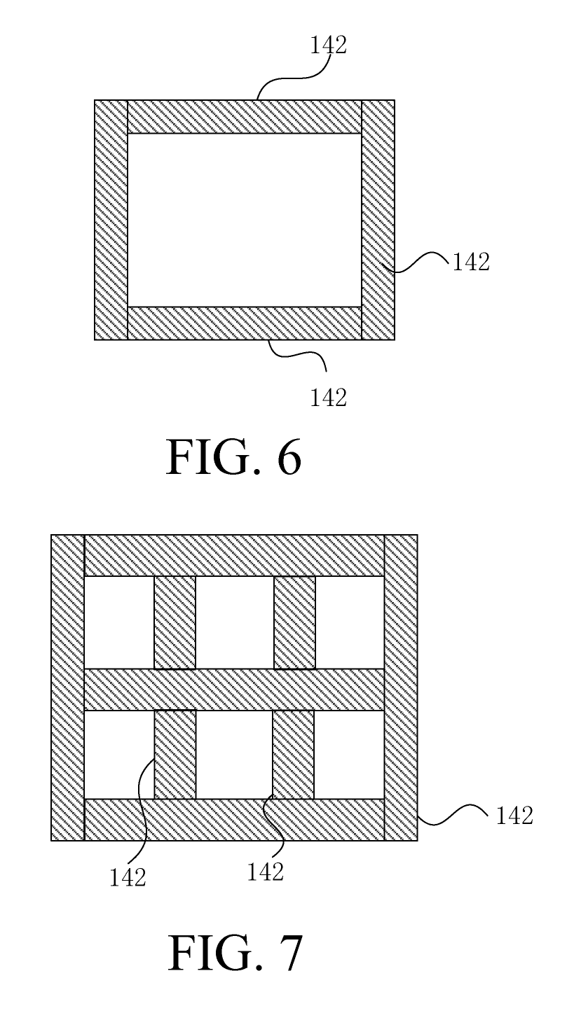

Referring to FIG. 3, FIG. 4, FIG. 6 and FIG. 7, FIG. 6 and FIG. 7 are schematic diagrams showing the curing units according to the first embodiment of the present invention. The curing units 142 of the curing device 140 of the present embodiment may be arranged according to a sealant pattern of the sealant 105. That is, the curing units 142 are arranged corresponding to the sealant pattern of the sealant 105 for allowing that each curing unit 142 can be disposed above the sealant 105 (or at one side thereof) for curing. For example, the sealant 105 is formed around the display panel 101, and thus the sealant pattern thereof is formed as a frame-shaped pattern. At this time, the curing units 142 of the curing device 140 can also be arranged as another frame-shaped pattern corresponding to the sealant pattern, thereby allowing that each curing unit 142 can be disposed above the sealant 105 for curing.

Referring to FIG. 5 through FIG. 7 again, in this embodiment, the curing units 142 of the curing device 140 are detachably disposed above the supporting stage 141 for curing the sealant 105. For example, the curing units 142 can be assembled on a supporting board 143 of the curing device 140 by screwing, fastening or other manners. Therefore, the disposed position or number of the curing units 142 can be adjusted according to the sealant pattern of the sealant 105. That is, the curing units 142 can be arranged according to the size or number of the display panel 101 for curing the sealant 105 thereof.

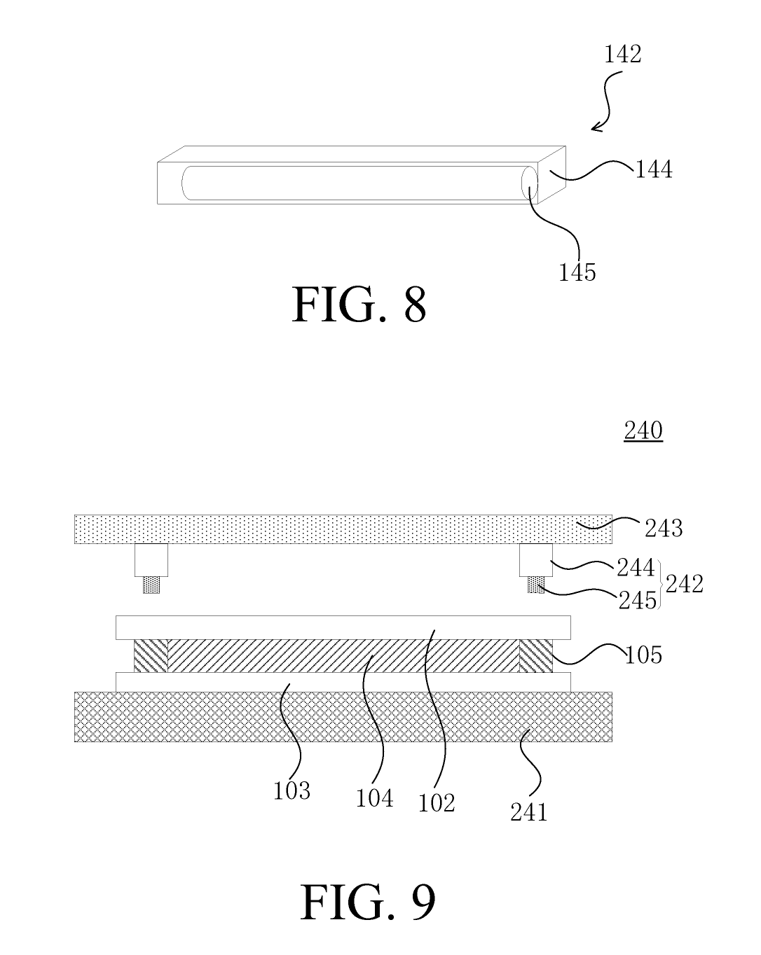

Referring to FIG. 8, a schematic diagram showing a curing unit according to the first embodiment of the present invention is illustrated. In this embodiment, the curing units 142 can cure the sealant 105 between the first substrate 102 and second substrate 103 using a light curing method. In the light curing method, a visible light (wavelength about 380 nm-780 nm) or an invisible light (such as UV light or infrared light) can be used to cure the sealant 105. At this time, the curing units 142 may emit light to the sealant 105 for light curing. In this embodiment, each of the curing units 142 may comprise a supporting bar 144 and a light source 145. The supporting bar 144 may be detachably arranged on the supporting board 143 in accordance with the sealant pattern of the sealant 105. The light source 145 may be, for example, a UV light lamp or light emitting diodes (LEDs) disposed on the supporting bar 144. Therefore, with the arrangement of the supporting bar 144, the curing units 142 may be arranged in accordance with the sealant pattern of the sealant 105.

Referring to FIG. 5 again, in this embodiment, for precisely aligning the curing units 142 above the sealant 105, i.e. for allowing that the curing units 142 can be arranged according to the sealant pattern of the sealant 105, the curing device 140 may further include at least one sensor 146, such as a charge-coupled device (CCD), for detecting whether the curing units 142 are arranged according to the sealant pattern of the sealant 105. The sensor 146 can be disposed at any position of the curing device. For example, the sensor 146 can be disposed at one side of the curing units 142. At this time, the curing units 142 and the display panel 101 can include alignment marks, respectively, and the sensor 143 can detect whether the curing units 142 are aligned with the sealant 105 by sensing the alignment marks. Furthermore, the supporting stage 141 of the curing device 140 can move the display panel 101 according to a sensing result of the sensor 146, thereby allowing that the sealant 105 of the display panel 101 can precisely aligned with the curing units 142.

In the assembly process of the display panel 101, when using the curing device 140 of the present embodiment to cure the sealant 105 of the display panel 101, the curing unit 142 can be aligned with the sealant pattern of the sealant 105 for curing. In comparison with the conventional UV curing machine with densely arranged UV lamps, since the curing unit 142 are arranged in accordance with the sealant pattern of the sealant 105 for curing, the number and used power of the curing unit 142 can be significantly reduced using the curing device 140, and the mask is not necessary for sheltering the liquid crystal layer, thereby reducing the unnecessary process cost.

Referring to FIG. 9, a schematic diagram showing a curing device according to a second embodiment of the present invention is illustrated. Only the difference between the embodiment and the first embodiment will be described hereinafter, and thus the similar portions there-between will be not stated in detail herein. In comparison with the first embodiment, the curing device 240 of the second embodiment can cure the sealant 105 using the heat curing method. At this time, the curing device 240 comprises a supporting stage 241 and a plurality of curing units 242. Each of the curing units 242 may comprise a supporting bar 244 and a heater 245. The supporting bar 244 may be detachably arranged on the supporting board 243 in accordance with the sealant pattern of the sealant 105. The heater 245 is disposed on the supporting bar 244. Therefore, with the arrangement of the supporting bar 244, the curing units 242 may be arranged in accordance with the sealant pattern of the sealant 105 for curing the sealant 105 of the display panel 101 in the heat curing manner.

As described above, the curing device and the display panel assembly apparatus using the same of the present invention can arrange the curing units corresponding to the sealant pattern of the sealant of the display panel, thereby significantly reducing the number and used power of the curing units. Therefore, the apparatus and process cost can also be significantly reduced. Furthermore, in this curing device, the number and position (or pitch) of the curing units can be adjusted according to the size or number of the display panel which is needed to be cured, and thus suitable to be applied to the display panel with various sizes and number.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A curing device for curing a sealant of a display panel, wherein the curing device comprises:
a supporting stage configured to support the display panel;
a plurality of curing units disposed above the supporting stage, wherein the curing units are arranged according to a sealant pattern of the sealant, and the curing units and the display panel include alignment marks, respectively; and
at least one sensor configured to detect whether the curing units are aligned with the sealant by sensing the alignment marks.

2. A curing device for curing a sealant of a display panel, wherein the curing device comprises:
a supporting stage configured to support the display panel; and
a plurality of curing units disposed above the supporting stage, wherein the curing units are arranged according to a sealant pattern of the sealant.

3. The curing device according to claim 2, wherein the sealant pattern is formed as a frame-shaped pattern.

4. The curing device according to claim 2, wherein the curing units cure the sealant using a light curing method.

5. The curing device according to claim 4, wherein each of the curing units comprises a supporting bar and a light source, and the light source is disposed on the supporting bar.

6. The curing device according to claim 2, wherein the curing units cure the sealant using a heat curing method.

7. The curing device according to claim 6, wherein each of the curing units comprises a supporting bar and a heater, and the heater is disposed on the supporting bar.

8. The curing device according to claim 2, wherein the curing device further comprises at least one sensor to detect whether the curing units are arranged according to the sealant pattern.

9. The curing device according to claim 2, wherein the curing units are detachably disposed above the supporting stage.

10. A display panel assembly apparatus, wherein the display panel assembly apparatus comprises:
a liquid crystal filling device configured to form a liquid crystal on a first substrate, wherein a sealant needed to be cured is formed on the first substrate;
an alignment assembly device configured to align and assemble a second substrate on the first substrate for forming a display panel;
a transporting device configured to transport the display panel from the alignment assembly device; and
a curing device configured to completely cure the sealant of the display panel transported by the transporting device, wherein the curing device comprises:
a supporting stage configured to support the display panel; and
a plurality of curing units disposed above the supporting stage, wherein the curing units are arranged according to a sealant pattern of the sealant.

11. The display panel assembly apparatus according to claim 10, wherein the sealant pattern is formed as a frame-shaped pattern.

12. The display panel assembly apparatus according to claim 10, wherein the curing units cure the sealant using a light curing method.

13. The display panel assembly apparatus according to claim 12, wherein each of the curing units comprises a supporting bar and a light source, and the light source is disposed on the supporting bar.

14. The display panel assembly apparatus according to claim 10, wherein the curing units cure the sealant using a heat curing method.

15. The display panel assembly apparatus according to claim 14, wherein each of the curing units comprises a supporting bar and a heater, and the heater is disposed on the supporting bar.

16. The display panel assembly apparatus according to claim 10, wherein the curing device further comprises at least one sensor to detect whether the curing units are arranged according to the sealant pattern.

17. The display panel assembly apparatus according to claim 16, wherein the curing units and the display panel include alignment marks, respectively, and the sensor detects whether the curing units are aligned with the sealant by sensing the alignment marks.

18. The display panel assembly apparatus according to claim 10, wherein the curing units are detachably disposed above the supporting stage.
